(19) United States
(12) Patent Application Publication
(10) Pub. No.: US 2024/0120117 A1
(43) Pub. Date: Apr. 11, 2024

(54) MOLTEN SALT FISSION REACTOR WITH INTEGRATED PRIMARY EXCHANGER AND ELECTROGENERATOR COMPRISING SUCH A REACTOR

(71) Applicant: NAAREA, NANTERRE (FR)

(72) Inventor: Jean-Luc ALEXANDRE, Aigremont (FR)

(21) Appl. No.: 18/264,868

(22) PCT Filed: Feb. 15, 2022
(86) PCT No.: PCT/FR2022/050270

§ 371 Date: Aug. 9, 2023

(30) Foreign Application Priority Data
Feb. 16, 2021 (FR) FR2101490

(51) Int. Cl. G21C 15/12; G21C 3/54; G21C 5/16; G21C 11/02; G21C 11/06; G21C 15/243; G21C 15/28; G21C 19/28

(52) U.S. Cl. CPC G21C 15/12; G21C 3/54; G21C 5/16; G21C 11/024; G21C 11/06; G21C 15/243; G21C 15/28; G21C 19/28

(57) ABSTRACT

Molten salt nuclear fission reactor including a core through which a fuel salt flows, a unit for circulating the fuel salt, a primary heat exchanger through which a heat-transfer salt flows, a primary enclosure which is impermeable to liquid salts and contains the reactor core, and a shelter. The reactor includes a parallelepiped matrix including alternating layers of fuel salt channels, and layers of heat-transfer salt channels. The matrix forms both the reactor core, in which the fission occurs, and the primary heat exchanger of the reactor. The circulating unit is entirely located within the primary enclosure and are configured to extract the fuel salt from one portion of the fuel salt channels on one side of the matrix and to propel the fuel salt into the other portion of the channels on the same side of the matrix.

### CROSS-REFERENCE TO RELATED APPLICATIONS

This application is the US national stage of PCT/FR2022/050270, filed Feb. 15, 2022 and designating the United States, which claims the priority of FR FR2101490, filed Feb. 16, 2021. The entire contents of each foregoing application are incorporated herein by reference.

### BACKGROUND OF THE INVENTION

### Field of the Invention

The present application relates to a molten salt nuclear fission reactor of the type with an integrated primary exchanger, as well as an electrogenerator comprising such a reactor.

### Description of the Related Art

A molten salt nuclear fission reactor usually comprises, on the one hand a reactor core in which a fuel salt undergoes self-sustaining nuclear fission reactions, and on the other hand a primary heat exchanger in which the hot fuel salt transfers heat to a heat-transfer salt.

Throughout the description, the term “fuel salt” refers to a composition comprising:
at least one carrier salt, for example a fluoride such as LiF, BeF₂ or NaF or a chloride, which carrier salt is in the solid state (crystals) at room temperature but becomes liquid beyond a certain temperature which will allow starting up the reactor, and
a fuel based on heavy nuclei comprising fissionable or fissile isotopes, for example Uranium 233 and/or uranium 235 and/or Plutonium 239 or a mixture thereof.

In other words, the expression “fuel salt” does not refer only to one or more salt(s) but to the entirety of the fuel composition.

The terms “heat-transfer salt” refers to a composition comprising at least one salt, for example a chloride or a fluoride, which composition is capable of storing heat, is devoid of fissionable or fissile heavy nuclei and of radioactive materials, is located in the solid state (crystals) at room temperature and becomes liquid beyond a certain temperature. Herein again, the expression “heat-transfer salt” does not only refer to the salt(s) in the strict sense but the entirety of the calorific composition that is used in the primary heat exchanger.

In most known molten salt reactors, the core is enclosed in a reflective enclosure capable of reflecting the neutrons generated by the nuclear fission; the primary heat exchanger is arranged outside this reflective enclosure and has its own enclosure; the fuel salt is pumped from the core towards the exchanger by a pump arranged outside the reflective enclosure of the core. All these elements are brought together in a reactor vessel.

Such a reactor has a large size. In order to reduce the latter, reactors with an integrated primary exchanger have appeared, such as that one disclosed by WO2015017928. In this reactor, the core is contained in a reflective reactor skirt, itself contained in a main vessel. The reactor skirt has a cylindrical portion with a circular section enclosing the core of the reactor, surmounted by a reflective cap and a central duct passing through the reflective cap.

In this known earlier reactor, the reactor core is filled with a moderating structure made of graphite in which channels are formed for the circulation of the fuel salt.

Moreover, the primary heat exchanger is arranged in the main vessel above the core. The exchanger comprises an inlet pipe which enters the main vessel, a plurality of pipes arranged around the central duct of the reactor skirt, which pipes are immersed in the fuel salt and are supplied with heat-transfer salt by the inlet duct, and an outlet duct through which the heat-transfer salt heated by the fuel salt in the exchanger comes out of the main vessel.

The core of the reactor, materialised by the moderating structure, in which the nuclear fission of the heavy nuclei of the fuel salt takes place, is separated from the primary exchanger by the central duct and by the reflective cap surmounting the core.

Accommodating the heat exchanger in the main vessel above the core has allowed reducing the size of the reactor and suppressing some circuits, valves and pumps necessary for the operation of the primary heat exchanger, thereby reducing the risks of breakdowns and malfunctions. Yet the known molten salt reactors remain bulky, in particular because they should operate well beyond the critical mass of the fuel salt.

Furthermore, the use of control rods is still necessary to avoid any risk of overheating of the core. These control rods are slidably mounted according to the longitudinal direction of the reactor so as to be able to be more or less immersed in the core of the reactor. They allow, in combination with the moderating structure made of graphite and according to the length of the immersed control rod, controlling the temperature of the fuel salt and the speed of the neutrons generated by fission.

Control of the reactor with such control rods is particularly tricky. In addition, the presence of the control rods, which should be able to be moved between a position almost entirely immersed and a position almost entirely removed off the core, considerably increases the height and the size of the known reactors.

Finally, the moderating structure made of graphite has an additional drawback, which limits the service life of the reactor: the graphite wears out and crumbles over time and graphite particles could mix with the fuel salt, thereby destabilising the neutron balance of the core and/or modifying its temperature.

Henceforth, an emergency cooling circuit is provided in the known prior reactors, which not only adds to the size of the reactors as well as to the risks of breakdowns, but also adds to the manufacturing and maintenance costs of the reactors.

WO2010/129836 describes a nuclear fission reactor which comprises a parallelepipedal matrix serving as a reactor core and as a primary heat exchanger. The matrix is immersed in a pool of fertile salt serving both as a moderator (for thermal spectrum operation), as a heat-transfer salt and as a vector of nuclei to be fertilised. The matrix comprises fuel salt channels, closed to the fertile heat-transfer salt and traversed by a fuel salt, and channels opening into the pool, traversed by the fertile heat-transfer salt. The fuel salt passes through the channels of the matrix from the bottom to the top, from the lower face of the matrix up to its upper face, then is conveyed back to the lower face from the outside of the matrix by a set of hoses and pumps immersed in the pool.

Compared to the reactor of WO2015017928, the matrix proposed by WO2010/129836 allows reducing the size of the reactor by combining the reactor core and the primary heat exchanger. Yet the risks of breakdowns and malfunctions related to the large number of hoses and pumps outside the matrix are still present, these hoses and pumps having also counterbalanced the gain in size conferred by the matrix. Furthermore, the presence of these hoses and pumps in the fuel salt circuit makes it necessary to provide a mass of fuel salt much larger than the critical mass of the fuel salt, which further limits the possible gain in terms of space. In addition, the reactor operating in thermal spectrum, it is necessary to provide for regulation means (pool of fertile heat-transfer salt, possibly supplemented by control rods) as well as an emergency evacuation tank, as well as a fuel salt reprocessing and regeneration circuit.

US2014/0348287 proposes another type of fission reactor comprising a serpentine traversed by a fuel salt, immersed in a vessel of liquid lead for cooling thereof.

### SUMMARY OF THE INVENTION

The invention aims to overcome at least one of the aforementioned drawbacks, by providing an incredibly compact molten salt reactor, with an increased and guaranteed service life, and increased safety.

To do so, the invention provides a molten salt nuclear fission reactor comprising:
a reactor core crossed by a fuel salt comprising fission-capable heavy nuclei,
a primary enclosure containing the reactor core, which primary enclosure is impermeable to liquid salts,
a shelter in which the primary enclosure is accommodated,
the reactor core comprising a parallelepipedal matrix comprising an alternation of layers (or plates) of fuel salt channels, in which the fuel salt circulates, and layers (or plates) of heat-transfer salt channels, in which a heat-transfer salt circulates; the matrix therefore forms both the core of the reactor, defined as being the volume in which fission takes place, and a primary heat exchanger,
heat-transfer salt circulation means for circulating the heat-transfer salt within the primary enclosure between a heat-transfer salt inlet opening of the primary enclosure, the heat-transfer salt channels of the matrix, then a heat-transfer salt outlet opening of the primary enclosure,
fuel salt circulation means for circulating the fuel salt in the fuel salt channels of the matrix.
the reactor according to the invention is characterised in that the fuel salt circulation means are configured to extract the fuel salt from one portion of the fuel salt channels through one face of the matrix and to propel the fuel salt into the other portion of the fuel salt channels through this same face of the matrix.

In other words, it being specified that each fuel salt channel has an inlet end and an outlet end, all fuel salt channels have their inlet opening and/or their outlet opening (i.e. either their inlet opening, or their outlet opening, or both) located on the same face of the matrix.

The fuel salt comes out of the matrix on one side of the matrix and gets in the matrix again on the same side thereof; the fuel salt circulation means do not lead the fuel salt from one side of the matrix to the other outside the latter (in contrast with what is suggested by WO2010/129836).

This allows considerably reducing the mass of fuel salt necessary for the operation of the reactor and thus providing a particularly compact reactor, with a small size and a low power. It should be noted that the parallelepipedal shape of the matrix (i.e. of the reactor core) also contributes to the compactness and efficiency of the reactor.

Henceforth, the dimensions of the primary enclosure may be reduced as much as possible. As this will be seen later on, the walls of the primary enclosure may even be bonded to the matrix on at least two of the faces of the latter. Indeed, according to the embodiments, only one volume above the matrix, and possibly one volume below the matrix, is or are provided between the matrix and the primary enclosure for the fuel salt circulation needs, and only a lateral volume on one side of the matrix, and possibly a lateral volume on the side opposite to the matrix, is or are provided between the matrix and the primary enclosure for the heat-transfer salt circulation needs.

The objective herein is to provide a reactor whose size does not exceed a few m³ (it may even be in the range of 1 m³) and whose power is in the range of a few megawatts, while known reactors compete in gigantism and power. For comparison, WO2010/129836 provides a reactor sized to deliver a power of 400 MW and whose matrix alone has a side of more than 2.40 m.

No moderating device (no control rod or other moderating structure made of graphite, no pool of liquid salt or liquid lead, etc.) is provided in the core, which operates in fast spectrum, which means that the neutrons generated by the nuclear fission of the fuel salt are not slowed down in the matrix.

According to a possible feature of the invention, the fuel salt circulation means are configured to circulate the fuel salt only inside the primary enclosure, in a closed cycle without regeneration of the fuel salt, the primary enclosure having no fuel salt outlet opening.

According to a possible feature of the invention, the shelter comprises at least:
a reflective layer made of a carbonaceous material, oriented towards the reactor core and configured to make the fuel salt critical, a shielding layer for abating residual radiations and neutrons, configured
to absorb or neutralise the gamma radiations originating from the core of the reactor and/or the reflective layer as well as residual leakage neutrons escaping from the primary enclosure which would manage to pass through the reflective layer of the shelter.

As regards the carbonaceous reflective layer of the shelter, a person skilled in the art is able to define, using a common neutron code simulator, according to the actual composition of the fuel salt and of the carbonaceous material selected to make the layer reflective, the layer thickness which allows guaranteeing criticality. Thus, for example, the reflective layer may be made of graphite and have a thickness comprised between 15 and 30 cm. In order to increase the service life of the reactor while avoiding overconsumption of fuel salt, the reflective layer preferably comprises not only a mass of graphite but also boron needles.

Similarly, a person skilled in the art is able to size the shielding layer so that it captures all the radiations emitted by the fission fuel salt in the core of the reactor and by the neutrons reflected or slowed down by the reflective layer as well as any residual neutrons that manage to cross the reflective layer of the shelter. A thickness of 5 to 20 cm of lead is suitable for making this shielding layer.

According to a possible feature of the invention, all fuel salt channels extend, in the layers of fuel salt channels, according to the vertical direction (they therefore extend according to a direction that is orthogonal to the upper and lower faces of the matrix), and all heat-transfer salt channels extend, in the layers of heat-transfer salt channels, according to a horizontal direction orthogonal to a first one of the lateral faces of the matrix. Since the matrix is parallelepipedal, the direction of the heat-transfer salt channels is also orthogonal to the lateral face of the matrix, hereinafter referred to as the second lateral face, which is opposite to the aforementioned first lateral face.

Preferably in this case, the fuel salt circulation means comprise:
an element, called central collector, comprising on one side a large base adjacent to the upper face of the matrix, which large base covers a central portion or slice of said upper face, and on the other side a top opening, an inner face in the form of a pyramidal hopper connecting the large base to the top opening,
and a centrifugal pump arranged opposite, above, the top opening of the central collector.

Advantageously, the central collector and the centrifugal pump are integrated into the primary enclosure. Thus, the fuel salt does not come out of the primary enclosure. It should be noted that the motor drive and the control electronics associated with the centrifugal pump for operation thereof are on the other hand arranged outside the primary enclosure, and preferably outside the reflective layer of the shelter, and possibly outside the shelter.

According to a possible feature of the invention, at least part of the heat-transfer salt circulation means are arranged inside the primary enclosure.

According to a possible feature of the invention, the heat-transfer salt circulation means also comprise a collector integrated into the primary enclosure, the collector having on one side a large base adjacent to the first lateral face of the matrix and on another side (which may be the side opposite to the large base or a side adjacent thereto) at least one opening connected either to the heat-transfer salt inlet opening of the primary enclosure, or to the heat-transfer salt outlet opening of the primary enclosure.

They also comprise at least one pump which, on the other hand, is preferably arranged outside the primary enclosure, and possibly outside the shelter or at the very least outside the reflective layer of said shelter.

For safety reasons, a second pump may be provided to ensure redundancy in the event of failure of the first pump and thus guarantee the circulation of the heat-transfer salt. Preferably, this second pump is also arranged outside the primary enclosure or the reflective layer of the shelter.

According to a possible feature of the invention, the matrix is made in one-piece. This allows guaranteeing perfect sealing between the layers of fuel salt channels and the layers of heat-transfer salt channels in order to avoid radioactive fuel salt mixing with the heat-transfer salt and thus coming out of the core of the reactor.

According to a possible feature of the invention, the matrix is made of one or more material(s) selected from among: graphene, silicon carbide (SiC) foams, graphene and silicon carbide foams (hereinafter denoted graphene/SiC foam) and combinations of the previous materials. For example, provision may be made to make the matrix of graphene/SiC foam, by covering the faces of each fuel salt layer with a sheet of graphene in order to seal said layers.

Preferably, the fuel salt central collector and the centrifugal pump, or more generally the fuel salt circulation means, are also made of graphene.

The use of graphene has many advantages: this material is 3D printable; it is an excellent thermal conductor, which is important since the matrix is not only the core of the reactor but also the primary heat exchanger of the reactor; it is extremely mechanically resistant; furthermore, unlike graphite, it does not crumble and has a high resistance to wear. SiC carbide foams and graphene and SiC foams have the same advantages, with the addition of a lower volumetric mass.

According to a possible feature of the invention, the matrix is obtained by 3D printing, the expression “3D printing” encompassing any additive manufacturing technique. This manufacturing process is particularly suitable to the shape and architecture of the matrix; it allows obtaining very easily and from one single material the layered structure and the multiple channels of the latter, without any seal or adhesive material or fastening part being necessary for the assembly of the different layers of the matrix.

In other words, 3D printing allows obtaining a one-piece matrix. The invention is not limited to the use of 3D printing, other processes may be used including to obtain a one-piece matrix (for example, in the case of a matrix with open-through channels, these may be obtained by drilling a carbonaceous material block).

According to a possible feature of the invention, besides its reflective layer and its outer shielding layer, the shelter comprises a thorium layer, which will be fertilised (transformed into U-233) by absorption of the leakage neutrons escaping from the primary enclosure. Advantageously, this thorium layer is provided between the reflective layer and the shielding layer so that the leakage neutrons are slowed down by the reflective layer and penetrate the thorium layer in thermal spectrum.

According to a possible feature of the invention, an upper cavity is provided between the upper face of the matrix and the upper wall of the primary enclosure on the one hand to accommodate the fuel salt circulation means and to ensure homogenisation of said salt, and on the other hand to receive a gaseous headspace, and the reactor further comprises a gaseous fission product recovery tank, connected to the gaseous headspace, in order to recover gaseous fission products, in particular xenon and/or krypton.

As already mentioned hereinabove, the other fission products are neither recovered nor reprocessed during an operating cycle of the reactor. Advantageously, the reactor is sized so that such a cycle lasts ten to fifteen years. The fuel salt is completely drained and renewed at the end of each cycle.

According to a possible feature of the invention, the reactor also comprises a neutral gas buffer tank and means for injecting said neutral gas into the gaseous headspace for compensating for variations in volume of the fuel salt.

Indeed, the fuel salt undergoes significant variations in volume, which could go up to 25%, which should be compensated for:
when the volume of the fuel salt decreases, by injecting neutral gas into the primary enclosure in the gaseous headspace in order to avoid any cavitation phenomenon,
when the volume of the fuel salt increases, by recovering the gaseous fission products accumulated in the gaseous headspace.

According to a possible feature of the invention, a trace preheating system is provided in the heat-transfer salt circulation means. This preheating system allows raising the temperature of the heat-transfer salt to its melting temperature (for example in the range of 450° C.) in order to start the reactor.

It should be noted that the melting temperature of the fuel salt and of the heat-transfer salt in the core is on the other hand reached when the matrix loaded with fuel salt and accommodated in the primary enclosure is integrated into the shelter.

According to a possible feature of the invention, the reactor comprises a device for controlling the flow rate (or the rate) of extraction/injection of the heat-transfer salt from/into the primary enclosure, i.e. a device for controlling the flow rate (or rate) of circulation of the heat-transfer salt in the reactor. This device alone allows controlling the temperature of the reactor and the fission reaction.

In a reactor according to the invention, it is not necessary to provide for a moderating structure in the reactor core, or a control rod, or a cooling system, on the one hand because the reactor is by design capable of stabilising itself and on the other hand because the control of the flow rate of the heat-transfer salt allows actively varying the temperature of the core.

Indeed, as regards the tendency of the reactor to self-stabilise, upon an increase in reactivity, the temperature rises. The high thermal expansion of the fuel, due to its liquid salt nature, pushes it out of the active region of the core when it overheats, thereby decreasing its density in the active region of the core, and reducing the reactivity in the volume of the critical fission zone. The temperature drops immediately. Conversely, when the fuel salt cools down, its density at the core increases, the probability of fission, as well as its ability to generate heat, increase. These two effects confer on the reactor its inherent stability nature, and enable it to follow the power demand downstream (extraction of heat by the primary exchanger). The equilibrium temperature in the reactor core is about 700° C.

Henceforth, the temperature of the core, and therefore the thermal power produced by the reactor, are regulated only by controlling the heat-transfer salt extraction flow rate.

According to a possible feature of the invention, the fuel salt comprises at least one carrier salt selected from among chlorides including sodium chloride (NaCl) and fluorides.

According to a possible feature of the invention, the heat-transfer salt comprises at least one salt selected from among chlorides including sodium chloride (NaCl) and fluorides. This salt may be the same as the carrier salt of the fuel salt.

As mentioned hereinabove, the matrix according to the invention and the fuel salt circulation means associated therewith are particularly suitable for making a reactor with small dimensions, the cubic matrix of which may for example have a 35 cm to 120 cm side, and/or whose volume of fuel salt in the liquid state is less than 500 litres.

Such a reactor may be described as a “miniature reactor” (in particular when the sides of the matrix measure about 40 cm) or a “small reactor” (in particular when the sides of the matrix measure about 100 cm) compared to known molten salt reactors, which have dimensions very much larger than those mentioned before. The Inventors have noticed with surprise that the combination of the small dimensions of the matrix, of the original architecture of the matrix (parallelepipedal yarrow) and of the fuel salt circulation means, and of the closed-loop circulation of the fuel salt inside the matrix (without coming out of the latter except in a small volume on the side of the upper face of the matrix where the fuel salt circulation means are accommodated) leads to obtaining a reactor with faultless operation despite an amount of fuel salt close to the critical mass. In addition, the obtained efficiency is excellent and higher than the efficiencies of known reactors.

Moreover, the Inventors have also discovered that the reactor according to the invention could operate with a fuel salt that essentially contains, as a material at the origin of fission in the core of the reactor, by-products (or spent radioactive materials) from conventional nuclear powerplants such as plutonium with a low fissile isotope content, low uranium with a low fissile isotope content (depleted uranium is almost free of its natural isotope U-235) and/or minor actinides (neptunium-237, americium-241 and 243 and curium-244 and 245), only a very small amount of uranium 235 or 233 and/or plutonium 239 being necessary at first.

Thus, the reactor according to the invention may serve as an incinerator for by-products (or spent radioactive materials) from the nuclear industry while producing energy. Since the reactor operates in fast spectrum within the matrix, these by-products (or spent radioactive materials) are literally destroyed and made harmless.

As regards the shape of the fuel salt channels, two variants may be considered. In a first variant:
the fuel salt channels are rectilinear and open-through, extending from the upper face of the matrix to its lower face,
an upper cavity is provided between the upper face of the matrix and the upper wall of the primary enclosure to accommodate the fuel salt circulation means excluding the motor drive and control elements of said means,
a lower cavity is provided between the lower face of the matrix and the lower wall of the primary enclosure for the circulation of the fuel salt,
the fuel salt circulation means comprise, on the side of the upper face of the matrix,
a central collector having a large base, an inner face in the form of a pyramidal hopper and a top opening, the large base covering only a central portion or a central slice of the upper face of the matrix (i.e. covering only part of the channels, the channels opening out opposite the collector being hereinafter referred to as “central channels” whereas the channels not opening opposite the collector are called “peripheral channels”),
and a centrifugal pump configured to project the fuel salt coming from the central collector towards the peripheral portion or the peripheral slices of the upper face of the matrix.

Thus, the fuel salt is sucked in the central channels by the central collector and the centrifugal pump so that it circulates from the lower face of the matrix towards the upper face of the latter in the central channels, then it is projected towards the peripheral channels in which it circulates in the opposite way, i.e.
from the upper face towards the lower face of the matrix. Hence, the central channels have their outlet end on the side of the upper face of the matrix and their inlet end on the side of the lower face of the matrix, whereas the peripheral channels have their inlet end on the side of the upper face of the matrix and their outlet end on the side of the lower face of the matrix.

In the second variant considered for the fuel salt channels:
the fuel salt channels are U-shaped channels, both of the inlet and outlet ends of each fuel salt channel being located on the upper face of the matrix,
an upper cavity is provided between the upper face of the matrix and the upper wall of the primary enclosure to accommodate the fuel salt circulation means excluding the motor drive and control elements of said means and to ensure the homogenisation of the fuel salt.

Unlike the first variant, the lower face of the matrix may rest on the lower wall of the primary enclosure.

In this second variant, provision may be made that:
each layer of fuel salt channels comprises two U-shaped fuel salt channels arranged symmetrically on either side of a central axis of said layer, each U-shaped fuel salt channel having an outlet end located in a central slice of the upper face of the matrix and an inlet end located in a peripheral slice of said upper face (the upper face of the matrix is thus “divided” into a rectangular central slice including the outlet ends of all U-shaped channels and two rectangular peripheral slices extending on either side of the central slice and including the inlet ends of all U-shaped channels);
like the first variant, the fuel salt circulation means advantageously comprise, on the side of the upper face of the matrix,
on the one hand a central collector with a large base, an inner face in the form of a pyramidal hopper and a top opening, the large base covering only the central slice of the upper face of the matrix
and on the other hand a centrifugal pump configured to project the fuel salt coming from the top opening of the central collector towards the two peripheral slices of the upper face of the matrix.

Similarly, two variants may be considered for the heat-transfer salt channels: in a first variant, the heat-transfer salt channels are rectilinear and open-through and in a second variant, the heat-transfer salt channels are U-shaped channels.

More specifically, in the first variant:
the heat-transfer salt channels are rectilinear and open-through, extending from a first one of the lateral faces of the matrix, up to its opposite lateral face, called the second lateral face, all heat-transfer salt channels having an inlet end on the side of the first lateral face of the matrix and an outlet end on the side of the second lateral face of the matrix,
an upstream mixing cavity is provided between the first lateral face of the matrix and the first lateral wall of the primary enclosure, the “first lateral wall of the primary enclosure” referring to the wall of said enclosure which runs along the first lateral face of the matrix,
a downstream mixing cavity is provided between the second lateral face of the matrix and the second lateral wall of the primary enclosure, the “second lateral wall of the primary enclosure” referring to the wall of said enclosure which runs along the second lateral face of the matrix,
the heat-transfer salt inlet opening of the primary enclosure opens into the upstream mixing cavity (it is for example formed in the first lateral wall of the primary enclosure), whereas the heat-transfer salt outlet opening of the primary enclosure opens into the downstream mixing cavity (it is for example formed in the second lateral wall of the primary enclosure),
the heat-transfer salt circulation means comprise at least one pump external to the primary enclosure, preferably external to the reflective layer of the shelter, or external to the shelter, configured to inject the heat-transfer salt into the upstream mixing cavity through the heat-transfer salt inlet opening of the primary enclosure, or to extract the heat-transfer salt from the downstream mixing cavity through the heat-transfer salt outlet opening of the primary enclosure.

In the second variant relating to the shape of the heat-transfer salt channels:
the heat-transfer salt channels are U-shaped channels, each U-shaped heat-transfer salt channel having an inlet end and an outlet end both located on the first lateral face of the matrix,
one single lateral cavity is provided, between the first lateral face of the matrix and the first lateral wall of the primary enclosure,
the heat-transfer salt inlet opening and the heat-transfer salt outlet opening of the primary enclosure are both provided to open into the single lateral cavity;
they are for example formed in the first lateral wall of the primary enclosure, or in a face adjacent to the latter proximate to said first face so as to open into the single lateral cavity.

Preferably:
each layer of heat-transfer salt channels comprises two U-shaped heat-transfer salt channels arranged symmetrically on either side of a central axis of said layer, each channel having one of its ends located in a central slice of the first lateral face of the matrix and its other end located in a peripheral slice of said first lateral face (in other words, the first lateral face of the matrix is “divided” into three rectangular portions, namely a central slice including one of the ends—for example the outlet end—of the U-shaped channels and two peripheral slices including the other end—for example the inlet end—of the U-shaped channels).

To sum up, as regards the shape of the channels, four main embodiments may ultimately be considered:
a first embodiment wherein the fuel salt channels and the heat-transfer salt channels are rectilinear and open-through channels;
a second embodiment wherein the fuel salt channels and the heat-transfer salt channels are U-shaped channels;
a third embodiment wherein the fuel salt channels are rectilinear and open-through channels and the heat-transfer salt channels are U-shaped channels;
a fourth embodiment wherein the fuel salt channels are U-shaped channels and the heat-transfer salt channels are rectilinear and open-through channels.

In the second embodiment (where all channels are U-shaped channels), no fuel salt circulation and homogenisation cavity is provided between the lower face of the matrix and the lower face of the primary enclosure since the fuel salt comes out from all channels on the side of the upper face of the matrix (unlike the first and third embodiments where the fuel salt channels are open-through). Similarly, in this second embodiment, one single lateral cavity is necessary for mixing and circulating the heat-transfer salt (unlike the first and fourth embodiments where the heat-transfer salt channels are open-through).

Hence, the second embodiment (where all channels are U-shaped) is more compact than the others. It turns out that it is also more advantageous in terms of efficiency in the case of a “miniature” matrix, the sides of which do not exceed 45 cm and which is designed to produce a power in the range of 2 to 3 thermal megawatts (or in the range of one electric megawatt). It is also very effective also in the case of a “small” matrix whose sides measure about 100 cm and which is designed to produce a power in the range of one hundred thermal megawatts (or 30 to 50 MW(e)). Nonetheless, the first embodiment (where all channels are open-through) also provides very satisfactory results, in particular in the case of a “small” matrix sized to produce fifty electric megawatts or less.

According to a possible feature of the invention, the fuel salt channels and the heat-transfer salt channels have a dimension comprised between 5 mm and 12 mm in the direction of the thickness of the fuel salt layers and the heat-transfer salt layers. Preferably, as regards the fuel salt channels, this dimension is comprised between 7 mm and 12 mm, ideally in the range of 10 mm, when these channels are rectilinear and open-through channels, and between 5 mm and 10 mm, ideally in the range of 7 mm when they consist of U-shaped channels. Preferably, the dimension of the heat-transfer salt channels according to the direction of the thickness of the layers is comprised between 5 mm and 10 mm, ideally in the range of 7 mm, whether they consist of rectilinear and open-through channels or U-shaped channels.

The heat-transfer salt circulation means in the case where each of the layers of heat-transfer salt channels comprises two U-shaped channels are now described.

In this case, provision may be made for the heat-transfer salt circulation means comprising a central collector similar to that one described for the fuel salt circulation means (i.e. a central collector having a large base and a top opening connected by an inner face in the form of a pyramidal hopper), whose large base covers only the central slice of the first lateral face of the matrix and whose top opening is connected to the heat-transfer salt inlet or outlet opening of the primary enclosure.

Alternatively, the heat-transfer salt circulation means comprise an integral collector with integrated ducts, preferably with a parallelepipedal external shape, the integral collector having an inner front face, an opposite front face and four sidewalls, the inner front face extending opposite the first lateral face of the matrix. The inner front face of the collector forms three pyramidal hoppers, namely a central hopper extending opposite the central slice of the first lateral face of the matrix, and two peripheral hoppers extending opposite the two peripheral slices of the first lateral face of the matrix. The central hopper is extended by a duct formed across the thickness of the collector and opening onto a first lateral opening located on one of the sidewalls of the collector. Each of the peripheral hoppers is extended by a secondary duct formed across the thickness of the collector, the two secondary ducts joining a main duct (also formed across the thickness of the collector) which opens onto a second lateral opening located on one of the sidewalls of the collector, preferably that one the same where the first lateral opening is located. The first lateral opening of the collector is connected to the heat-transfer salt outlet opening of the primary enclosure, whereas the second opening of the collector is connected to the heat-transfer salt inlet opening of the primary enclosure, or vice versa.

Preferably, such an integral collector (with a triple hopper and integrated conduits) is made of graphite or graphene. It then contributes to the reflection of the neutrons coming from the core of the reactor. Advantageously, it is manufactured by 3D printing.

It also has two main advantages, compared to a central collector (with one single hopper) as described before. The first advantage is that it guarantees an equal distribution, in volume of heat-transfer salt injected (or extracted, depending on the imposed direction of circulation), between the two peripheral slices of the first lateral face of the matrix. The second advantage is that it also guarantees the thermal homogeneity of the heat-transfer salt at the inlet of the matrix because the cold heat-transfer salt entering the primary enclosure is directly injected into the matrix. Conversely, when a central collector with one single hopper is used, it cannot be completely excluded that the heat-transfer salt has a heterogeneous temperature in the lateral cavity, with colder areas or hot spots, due to insufficient mixing in said cavity.

Irrespective of the considered collector (central collector—with one single hopper—or integral collector—with three hoppers and integrated ducts —), the heat-transfer salt circulation means also comprise at least one pump external to the primary enclosure and possibly external to the reflective layer of the shelter, configured to extract the (hot) heat-transfer salt from the reactor through the heat-transfer salt outlet opening of the primary enclosure and through the top opening of the central collector or the first lateral opening of the integral collector (in the case where the top opening of the central collector or the first lateral opening of the integral collector is connected to said outlet opening) or to inject the (cold) heat-transfer salt into the collector via the heat-transfer salt inlet opening of the primary enclosure and through the top opening of the central collector or the first side opening of the integral collector (in the case where the top opening of the central collector or the first lateral opening of the integral collector is connected to said inlet opening).

As indicated in the introduction, the invention also provides an electrogenerator comprising a nuclear fission reactor according to the invention.

According to a possible feature, the electrogenerator comprises:
a secondary heat exchanger supplied with hot heat-transfer salt coming out of the reactor, and in which the hot heat-transfer salt transfers heat to carbon dioxide in the supercritical phase,
a supercritical CO₂ turbine connected to the outlet of the secondary heat exchanger,
an electric generator, for example a high-speed generator, coupled to or integrated with the supercritical CO₂ turbine,
a power electronic converter.

According to a possible feature, the supercritical CO₂ turbine is a turbine operating in a closed cycle with two-stage compression and intermediate cooling of only part of the fluid.

According to a possible feature, the generator comprises a closed outer case containing all of the previously defined elements, namely the nuclear fission reactor with an integrated primary heat exchanger, the secondary heat exchanger, the supercritical CO₂ turbine, the electric generator and the power electronic converter. Preferably, this outer case also encloses a computer control unit and telecommunication means connected to the control unit, like for example a 5G emitter/receiver, allowing remotely controlling the control unit which remains locally inaccessible for security reasons.

The control unit is configured to monitor a given number of so-called passive parameters, measured by appropriate sensors, and to actively control the flow rate or the circulation speed of the heat-transfer salt (by controlling the heat-transfer salt circulation pump), this last parameter being the only so-called active parameter of the electrogenerator (except for the means for orienting the ventilation fins of the outer case described later on).

Among the monitored passive parameters, mention may be made of the rotational speed of the centrifugal pump ensuring the circulation of the fuel salt, the pressure of the gaseous headspace, the pressure in the neutral gas buffer tank, the pressure in the recovery tank of the gaseous fission products, speed or the flow rate of the pump of the secondary heat exchanger or of the CO₂ turbine, the electric current and/or the electric voltage and/or the electric power derived from the generator, the temperature of the fuel salt in the matrix, the temperature of the heat-transfer salt at the outlet of the primary enclosure, the temperature of air inside the external case, etc.

According to a possible feature of the invention, the external case of the electrogenerator comprises orientable and motor-driven ventilation fins which can be pivoted between a closed position in which the external case is sealed and an open position enabling the circulation of air between the inside and the outside of the case to the heat release fins in case of overheating.

The invention covers a reactor and an electrogenerator characterised in combination by all or part of the features mentioned before and later on.

### BRIEF DESCRIPTION OF THE DRAWINGS

The invention, according to one embodiment, will be well understood and its advantages will appear better upon reading the following detailed description, given for indicative and non-limiting purposes, with reference to the appended drawings wherein:

FIG. 1 is a perspective view of a first embodiment of a matrix according to the invention;

FIG. 2 shows sections according to vertical planes of the matrix of FIG. 1; more specifically, the left portion of the figure is a cross-section according to a vertical plane YZ of a fuel salt layer of the matrix of FIG. 1; the right portion of FIG. 2 is a section according to a plane YZ of a heat-transfer salt layer of the matrix of FIG. 1;

FIG. 3 shows sections according to vertical planes of a second embodiment of a matrix according to the invention; more specifically, the left portion of the figure is a section of a fuel salt layer according to a vertical plane YZ whereas the right portion of the figure is a section of a heat-transfer salt layer according to a plane YZ;

FIG. 4 is an exploded perspective view of a portion of a reactor according to the invention illustrating the matrix of FIG. 1 with a portion of the fuel salt circulation means of the reactor;

FIG. 5 is a perspective view of the matrix of FIG. 1 with which a central collector is associated and two pumps for circulating the heat-transfer salt;

FIG. 6 is a perspective view of the matrix of FIG. 1 with which an integral collector is associated for the circulation of the heat-transfer salt;

FIG. 7 is a perspective view of an integral collector for the circulation of the heat-transfer salt, from an inner front face of said collector;

FIG. 8 is a perspective view of the integral collector of FIG. 7, from an outer front face of said collector;

FIG. 9 is an exploded perspective view of a portion of a reactor according to the invention illustrating the matrix of FIG. 1 with a portion of the heat-transfer salt circulation means of the reactor including the integral collector of FIGS. 7 and 8;

FIG. 10 is a schematic perspective illustration of an embodiment of an electrogenerator according to the invention, a portion of the outer case of which has been pulled off.

### DETAILED DESCRIPTION

Identical elements shown in the aforementioned figures are identified by identical reference numerals.

FIG. 1 shows a first embodiment of a matrix according to the invention wherein the fuel and heat-transfer salt channels are U-shaped channels. This matrix 10 comprises an alternation of fuel salt layers 11 and heat-transfer salt layers 12. The layers 11 and 12 have square sections (in YZ planes) and form a set that may be cubic. The matrix also comprises two end layers forming the first and second lateral faces 15 and 16 of the matrix. Advantageously, these end layers are heat-transfer salt layers, with a rectangular section (in YZ planes) with a height (according to the Z direction) larger than the height of the layers 11 and 12. The upper 13 and lower 14 faces may be square or rectangular.

Moreover, the matrix comprises a strip 19 at each of its third and fourth lateral faces 16, 17. The strips 19 and the overhanging (upwards) portion of the end layers 15, 16 delimit an upper cavity 200 intended to receive at least one portion of the fuel salt circulation means and to ensure mixing and thermal homogeneity of said fuel salt.

As will be seen later one, besides this upper cavity 200, the reactor core also includes at least one lateral cavity 201 (cf. FIG. 5 for example) opposite the first lateral face 15 of the matrix. This lateral cavity 201 is intended to receive at least one portion of the heat-transfer salt circulation means and to ensure mixing and thermal homogeneity of said heat-transfer salt.

The matrix is loaded with fuel salt in the fuel salt layers and with heat-transfer salt in the heat-transfer salt layers. Thus, the matrix forms both the core of the reactor according to the invention and its primary heat exchanger.

By definition, the fuel salt used in a reactor according to the invention contains heavy nuclei, including fissionable isotopes (capable of fissioning under the effect of a bombardment of fast or thermal neutrons) and/or fissile isotopes (capable of fissioning under the effect of a bombardment of a fast neutrons only), but also minor actinides intended to be incinerated in the reactor. Only a small proportion of fissionable isotopes and/or fissile isotopes is necessary.

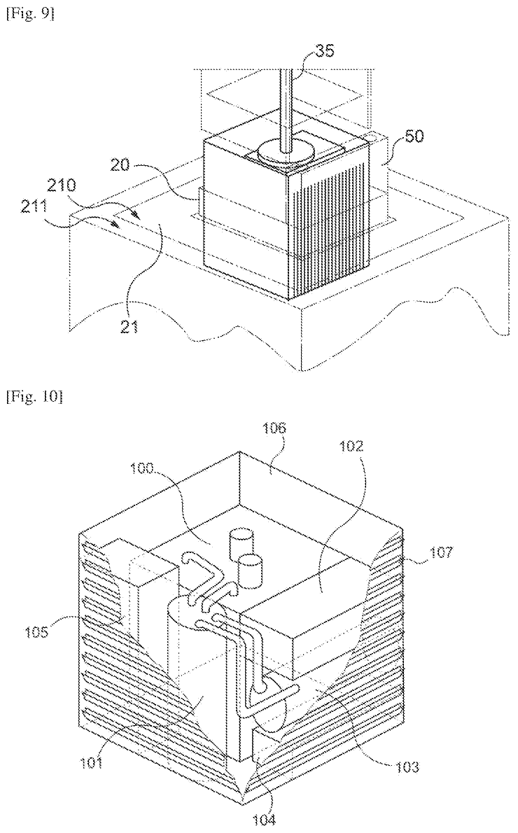

Besides such a matrix, a reactor according to the invention comprises a primary enclosure 20 and a shelter 21 such as those that could be seen in phantom lines in FIGS. 5, 6 and 9. The function of the primary enclosure 20 is to receive the matrix and to confine the fuel salt that it contains.

The shelter comprises at least one reflective layer 210 directed towards the inside of the reactor and an outer shielding layer 211. The reflective layer 210 essentially consists of a carbonaceous material like graphite or graphene. Advantageously, it comprises al 5 to 30 cm thick mass of graphite incorporating boron needles. Advantageously, the outer shielding layer 211 comprises a 5 to 20 cm thick mass of lead, possibly with boron needles where necessary.

When criticality is reached, fissile nuclei present in the fuel salt contained in the matrix start fissioning and generate fast neutrons which lead to the fission of other fissionable or fissile nuclei, as well as the disintegration of any minor actinides present. These neutrons being fast, they do not all reach a nucleus capable of fissioning and some escape from the primary enclosure; these are then reflected by the reflective layer 210 of the shelter or slowed down until being absorbed by the latter. Thus, almost all of the neutrons generated in the fuel salt channels of the matrix are reflected or absorbed by the reflective layer 210. The small percentage of residual neutrons managing to cross the reflective layer is absorbed by the shielding layer 211 made of lead of the shelter, which shielding layer also abates the gamma radiations emitted by the neutrons involved in a fission reaction in the matrix and by the neutrons slowed down in the reflective layer 210.

The reactor according to the invention also comprises means for circulating the fuel salt and means for circulating the heat-transfer salt, described later on according to the embodiments of the matrix. The circulation of the fuel salt in the reactor core allows guaranteeing a perfect thermal homogeneity of the fuel salt.

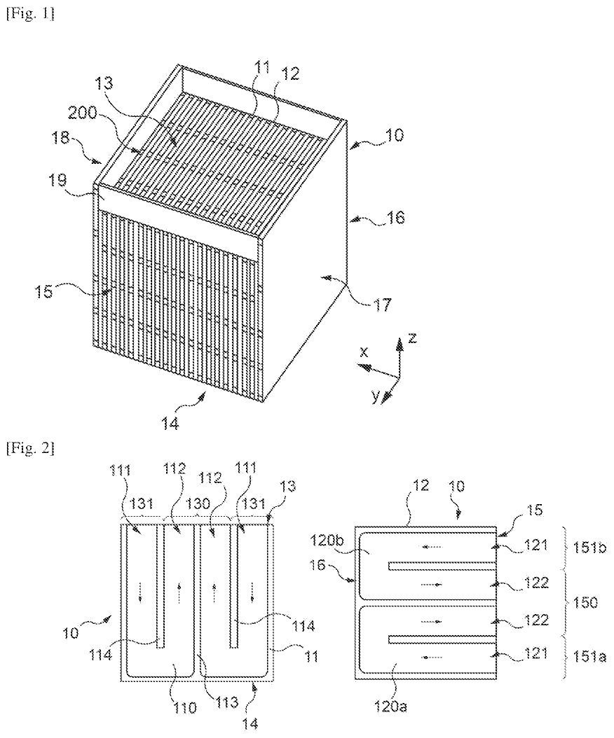

The layers of the matrix 10 (first embodiment) illustrated in FIG. 1 are visible in section in FIG. 2; they are all identical, with the exception of the end layers forming the lateral faces 17, 18 of the matrix.

Each fuel salt layer 11 (cf. left portion of the FIG. 2) has solid faces and is crossed by two U-shaped channels 110 symmetrical with respect to a vertical central axis of the layer, U-shaped channels in which the fuel salt circulates according to a vertical direction, from the top to the bottom then from the bottom to the top. Each fuel salt channel 110 has an inlet end 111 and an outlet end 112. The outlet ends 112 of the two channels are located in a central section 130 of the upper face 13 of the matrix. The inlet ends 111 of the two fuel salt channels are located in two peripheral slices 131 of the upper face 13 of the matrix.

Similarly, each heat-transfer salt layer 12 (cf. the right portion of FIG. 2) has solid faces and is crossed by two U-shaped channels symmetrical with respect to a horizontal central axis of the layer, in which U-shaped channels the heat-transfer salt circulates according to a horizontal direction, in one way (from the right of the figure to the left) then in the other way. Each heat-transfer salt channel 120a, 120b has an inlet end 121 leading into a peripheral slice 151a, 151b of the lateral face 15 of the matrix and an outlet end 122 leading into a central slice 150 of the lateral face 15 of the matrix.

In other words, the fuel salt and heat-transfer salt layers have the same structure but they are oriented with a 90° offset so that the U-shaped channels run essentially vertically in the fuel salt layers 11 and all open onto the upper face 13 of the matrix while they extend essentially horizontally in the heat-transfer salt layers 12 and all open onto one of the lateral faces of the matrix, in this case the face 15 (referred to as the “first” lateral face). In such a matrix, the lower face 14 and the lateral faces 16 to 18 are blind.

It should be noted that the end layers forming the lateral faces 17, 18 of the matrix are heat-transfer salt layers which preferably differ slightly from the other heat-transfer salt layers of the matrix in that they are not symmetrical with respect to their horizontal central axis. Thus, in the illustrated example, each of these end layers 17, 18 comprises a lower channel which is identical to the lower channel 120a of the other heat-transfer salt layers of the matrix, but an upper channel which is wider than the channel 120b of the other heat-transfer salt layers of the matrix. Hence, this upper channel extends partially opposite the upper cavity 200, which allows ensuring cooling of this cavity.

For example, each layer, whether it consists of a fuel salt layer 11 or a heat-transfer salt layer 12, is 10 mm thick (according to the X direction) and each salt fuel 110 or heat-transfer salt 120a, 120b channel preferably measures 7 mm in the direction of the thickness of the layer 11, i.e. according to the X direction. Hence, the fuel salt channels of a layer and the heat-transfer salt channels of the adjacent layer are distant by about 3 mm at their points of intersection. It should be noted that the scale is not complied with in the appended drawings, in particular in FIG. 2, the thickness of material 113 separating the two channels of the same layer and the thickness of material 114 separating the two branches of the same channel may be much finer compared to the width of the channels (according to the Y direction). For example, the width of the U-shaped channels may be in the range of 96 mm whereas the thickness of material 113 separating the two channels of the same layer and the thickness of material 114 separating the two branches of the same channel is 3 mm. A 40 cm side matrix is then obtained.

It is possible to provide for all heat-transfer salt layers to be identical, for example with 96 mm wide channels, except for the two end layers forming the lateral faces 17 and 18 of the matrix. Thus, for example, these end layers of heat-transfer salt comprise a 96 mm wide lower channel like the other layers and a wider upper channel, herein measuring 113 mm (cf. FIGS. 1 and 4). This allows circulating the heat-transfer salt on the lateral walls of the upper cavity 200 for cooling thereof.

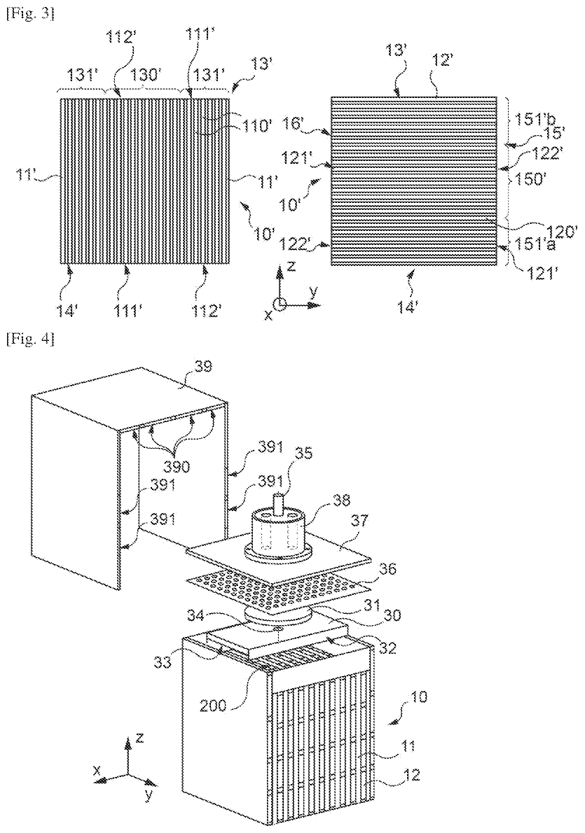

FIG. 3 shows a second embodiment of a matrix according to the invention in which the fuel salt and heat-transfer salt channels are straight and open-through.

Like the matrix 10 of the first embodiment, the matrix 10′ is cubic, its faces are consequently square and an upper strip is associated with the matrix to form an upper cavity above the upper face 13′ of the matrix. In addition, a lower strip (not shown) is also associated with the matrix 10′ to form a lower cavity below the lower face 14′ of the matrix. Two lateral cavities are also provided, including an upstream cavity opposite the face 15′ into which cold heat-transfer salt coming from a secondary heat exchanger is injected, and a downstream cavity opposite the face 16′ from which the hot heat-transfer salt coming out of the matrix is sucked towards the outside of the reactor core in the direction of the secondary heat exchanger.

Like the matrix 10, the matrix 10′ consists of an alternating superposition of layers of fuel salt 11′ and layers of heat-transfer salt 12′, which are identical or similar (slight differences may exist between the fuel salt layers and the heat-transfer salt layers in particular with regards to the diameter of the channels and/or the thickness of the layers) but pivoted by 90° with respect to each other.

Each fuel salt layer 11′ comprises rectilinear and open-through fuel salt channels 110′ all extending according to the vertical direction, from the upper face 13′ of the matrix up to its lower face 14′. The fuel salt circulates from the bottom to the top in the channels, referred to as central channels, located in the central slice 130′ of the layer, so that the inlet end 111′ of these central channels is located on the lower face 14′ of the matrix and the outlet end 112′ of these central channels is located on the upper face 13′ of the matrix. The fuel salt circulates in the other way in the channels, called peripheral channels, located in the two peripheral slices 131′ of the layer. Hence, the inlet end 111′ of these peripheral channels is located on the upper face 13′ of the matrix whereas the outlet end 112′ of the peripheral channels is located on the lower face 14′ of the matrix. Thus, the central channels are defined in the same manner for all of the fuel salt layers, so that, viewed from above, the upper face 13′ of the matrix may be “divided” into three rectangular slices, a central slice 130′ including the outlet ends of the central channels and two peripheral slices 131′ including the inlet ends of the peripheral channels.

For example, the fuel salt layers 11′ have a thickness between 10 mm and 15 mm (according to the X direction) and the heat-transfer salt layers 12′ have a thickness between 8 mm and 13 mm (according to the X-direction). Moreover, each fuel salt channel 110′ has a diameter comprised between 7 mm and 12 mm, preferably in the range of 10 mm, and the fuel salt channels are spaced apart by about 3 mm according to the Y direction, whereas each heat-transfer salt channel 120′ has a diameter comprised between 5 mm and 10 mm, preferably in the range of 7 mm, and the heat-transfer salt channels are spaced apart by about 3 mm according to the Z direction.

Irrespective of the used matrix, thanks to the upper strip 19, an upper cavity 200 (cf. FIG. 4) is formed above the matrix 10 between a cover 37, which closes the reactor core at its top, and the upper face 13 of the matrix, in order to accommodate, inter alia, the fuel salt circulation means, excluding the motor drive and the control unit of said means.

Moreover, when the reactor is equipped with a matrix with U-shaped channels such as the matrix 10 in FIG. 2, the matrix is placed directly on the lower wall of the primary enclosure 20. When the reactor is equipped with a matrix with open-through channels such as the matrix 10′ of FIG. 3, a space is left between the lower face 14′ of the matrix and the lower wall of the primary enclosure, for example using a lower strip (not shown) in order to form a lower fuel salt circulation and homogenisation cavity (not shown).

Whether the reactor is equipped with a matrix 10 (in accordance with FIG. 2) or with a matrix 10′ (in accordance with FIG. 3), the fuel salt circulation means may comprise a central collector 30 and a centrifugal pump 31 such as those illustrated in FIG. 4.

The central collector 30 has a large rectangular base 32 whose dimensions coincide with those of the central slice 130, 130′ of the upper face 13, 13′ of the matrix, an inner face 33 (lower face, oriented towards the matrix) in the form of a pyramidal hopper and a top opening 34. The collector is shown at a distance from the matrix in FIG. 4 since it consists of an exploded view, but of course, the collector is actually pressed against the upper face 13 of the matrix.

The centrifugal pump 31, with a vertical axis 35, is arranged above the top opening 33 of the collector; its rotation therefore causes the upward suction of the fuel salt contained in the channels of the matrix which extend opposite the collector (central channels in the case of the matrix 10′ and central branches of the U-shaped channels in the case of the matrix 10) and the projection of this salt towards the peripheral slices 131, 131′ of the upper face of the matrix. If the matrix is a matrix with U-shaped channels such as the matrix 10, the fuel salt is then pushed into the peripheral branches of the U-shaped channels (of the matrix 10), to return afterwards towards the upper face of the matrix via the central branches of the U-shaped channels. If the matrix is a matrix with open-through channels such as the matrix 10′, the fuel salt expelled from the centrifugal pump is pushed into the peripheral channels up to the lower mixing and homogenisation cavity of the reactor. Afterwards, it rises into the matrix through the central channels.

The collector 30 and the centrifugal pump 31 are accommodated in the upper cavity 200 provided in the reactor core above the matrix.

This upper cavity integrates, from the bottom to the top (cf. FIG. 4), not only the collector 30 and the centrifugal pump 31, but also:
a diffuser 36, composed by a perforated plate covering the entire surface of the upper cavity, and located just above the centrifugal pump; this diffuser 36 enables the salt to expand without being disturbed by the turbulences due to the circulation of the flow coming out of the pump towards the descending channels in the fuel salt layers;
a removable cover 37 with an expansion device and a degassing system. This cover 37 includes a device allowing accepting up to 25% expansion of the entire volume of fuel salt comprised in the core between its solid phase crystallised at low temperature, and its liquid phase when the salt is melted at high temperature,
a jumper 39 in which the heat-transfer salt circulates. This jumper includes four channels. Each of these channels has an inlet end 390 on the front face of the jumper in the horizontal wall of the latter, through which inlet end cold heat-transfer salt is injected. From this inlet end, the channel runs horizontally backwards according to the Y direction in the horizontal wall to “tilt” into the adjacent vertical wall then run again according to the Y direction (but forwards) in this vertical wall up to an outlet end 391 leading into the front face of the jumper in said vertical wall.

The vertical axis 35 of the centrifugal pump passes through the cover 37 to be coupled to a remote motor (not shown) located above the core outside the shelter 21. A sleeve 38 for sealing and centring the axis 35 of the centrifugal pump is fastened to the cover 37 of the upper cavity by means of a clamping flange with six screws (for example M6 screws) and a flat gasket made of stainless steel/carbon. This sleeve 38, made of a carbonaceous material, for example graphene, is long enough to pass through the upper walls of the primary enclosure 20 and of the shelter 21. It comprises the following systems or arrangements:
a set of tapered bearings allowing ensuring centring and adjustment of the height of the axis of the pump,
a set of very high temperature O-ring gaskets between the axis of the pump and the sleeve, ensuring dynamic sealing,
a set of very high temperature O-ring gaskets over the periphery of the sleeve, ensuring static sealing with respect to the upper walls of the enclosure and the shelter crossed by the sleeve,
one or more vertical inner channel(s) crossing the sleeve, called gas exchange channels, enabling gas exchanges between the upper cavity of the core and selective reservoirs (not shown) provided to this end. In the normal operating mode (hot reactor), the gases resulting from fission and the poisons of the reaction (in particular Xenon-135) are evacuated from the core through these gas exchange channels. In the reactor cold shut-down mode, a neutral gas is injected through one of the gas exchange channels allowing compensating for the reduction in the volume generated by the crystallisation of the salt; the sleeve may for example comprise two 5 mm diameter channels for the extraction of the fission gases and the injection of the neutral gas;
a vertical inner channel crossing the sleeve, called the filling/draining channel, to add or remove fuel salt to or from the matrix:
a set of measuring probes; the sleeve comprises for example two 5 mm diameter channels for the passage of temperature and/or pressure probes from the upper cavity of the core towards the outside of the shelter.

As indicated before, the reactor according to the invention also comprises means for circulating the heat-transfer salt. These means may comprise a central collector 40 such as that one visible in FIG. 5 and at least one pump 41. The example of FIG. 5 uses a matrix of U-shaped channels such as that one in FIGS. 1 and 2. Hence, a single lateral cavity 201 is provided between the matrix and the primary enclosure 20 for the homogenisation of the heat-transfer salt and accommodating a portion of the heat-transfer salt circulation means. This lateral cavity 201 is provided opposite the first lateral face 15 of the matrix 10. It should be noted that, in FIG. 5, the upper cavity 200 which accommodates the fuel salt circulation means could also be seen (not shown in this figure).

Like the fuel salt collector 30, the heat-transfer salt central collector 40 comprises a large base whose dimensions coincide with the central slice 150 of the first lateral face 15 of the matrix so that the collector 40 extends opposite the outlet ends 122 of the heat-transfer salt U-shaped channels. It should be noted that jumper 39 is not shown in FIG. 5. Nonetheless, it should be easily understood that, when the jumper 39 is in place, the outlet ends 391 of its channels open opposite the collector 40, whereas the inlet ends of said channels open into the cavity 201.

The collector 40 also comprises an inner face in the form of a hopper (not visible in FIG. 5) allowing guiding the heat-transfer salt sucked in at the central slice 150 of the first lateral face 15 up to a top opening 47 of the collector.

The heat-transfer salt circulation means also comprise:
an extraction duct 45 connecting the pump 41 to the top opening 47 of the central collector 40. This extraction duct 45 passes through the upper wall of the primary enclosure 20 through a heat-transfer salt outlet opening 42 formed in the upper wall of said enclosure in line with the lateral cavity 201,
an inlet duct 46 connecting the outlet of the secondary heat exchanger with the core of the reactor, which inlet duct 46 passes through the primary enclosure through a coolant salt inlet opening 43 formed in the upper wall of said enclosure in line with the lateral cavity 201, the duct 46 comprising an opening 44 leading into the lateral cavity 201 and allowing injecting cold heat-transfer salt into this cavity. Afterwards, this cold salt is distributed between the two peripheral slices 151a, 151b of the lateral face 15 of the matrix to enter the U-shaped channels through the inlet ends 121 of these, under the effect of the suction generated by the extraction pump 41.

In the example illustrated in FIG. 5, the heat-transfer salt circulation means comprise a redundant system with a second extraction pump, a second extraction duct connected to a second top opening of the collector 40, and a second inlet duct. This redundant system is optional, it is not essential.

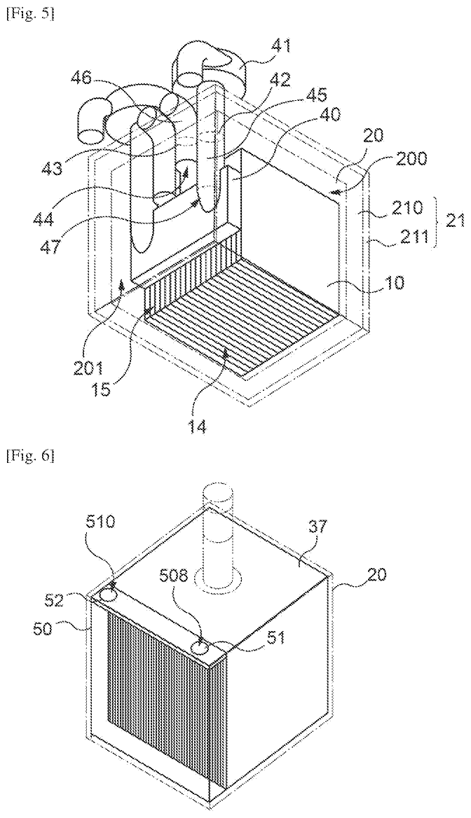

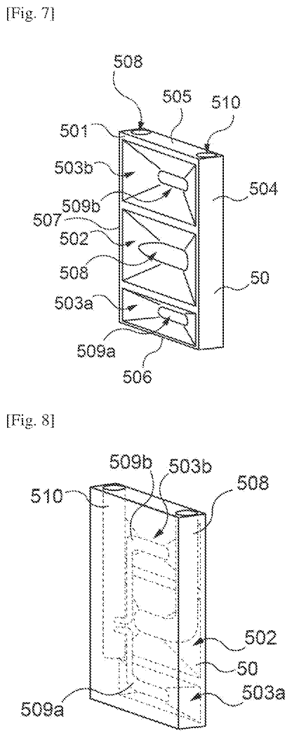

Instead of the central collector 40, the heat-transfer salt circulation means may comprise an integral collector 50 such as that one illustrated in FIGS. 6 to 9, associated with an extraction pump 41 similar to that one illustrated in FIG. 5. The integral collector 50 is a generally parallelepipedal element which occupies the entire lateral cavity 201. This integral collector 50 has:
an inner front face 501 which covers the entire surface of the first lateral face 15 or 15′ of the matrix and is pressed against the latter,
an opposite outer front face which is planar and extends opposite the first lateral face of the primary enclosure,
four sidewalls 504 to 507.

The inner front face 501 forms three pyramidal hoppers, including a central hopper 502 whose base corresponds to the central slice 150 or 150′ of the first lateral face of the matrix and two peripheral hoppers 503a, 503b. The lower hopper 503a corresponds to the lower peripheral slice 151a or 151′a of the first lateral face of the matrix and extends opposite the latter. The height of the upper hopper 503b is larger than that of the lower hopper 503a because it not only covers the upper peripheral slice 151b or 151′b of the lateral face 15 of the matrix but also the strip 19 so as to entirely cover the inlet ends of the larger upper channels which are provided in the end layers forming the lateral faces 17, 18 of the matrix, as well as the inlet ends 391 of the four channels of the jumper 39. In other words, the same asymmetry is found on the inner face 501 of the integral collector 50 as in the end layers of heat-transfer salt which form the lateral faces 17, 18 of the matrix.

The central hopper 502 opens into an extraction duct 508 formed across the thickness of the collector, a duct 508 whose outlet end is located on the upper sidewall 505 of the collector; this outlet end opens onto a heat-transfer salt outlet opening 51 formed in the upper wall of the primary enclosure 20 (cf. FIG. 6). This heat-transfer salt outlet opening 51 is connected by a duct (not shown) to an extraction pump (not shown) located outside the primary enclosure 20 or the shelter 21. Moreover, each peripheral hopper 503a, 503b opens into a secondary duct 509a, 509b (formed across the thickness of the collector) which joins a main duct 510 (also formed across the thickness of the collector) whose outlet end is located on the upper sidewall 505 of the collector; this outlet end opens onto a heat-transfer salt inlet opening 52 formed in the upper wall of the primary enclosure 20.

In order to ensure an equal distribution of the heat-transfer salt between the hoppers 503a and 503b, i.e. to have the same pressure (and the same flow rate) of heat-transfer salt in all heat-transfer salt channels of the matrix while the hoppers 503a and 503b are not symmetrical, the lower secondary duct 509a has a smaller section than the secondary duct 509b.

The invention covers an electrogenerator such as that one schematically shown in FIG. 10. This electrogenerator comprises:
a reactor 100 as described before,
a salt/CO₂ secondary heat exchanger 101,
a turbine 103,
a generator; in the illustrated example, the turbine 103 is a turbine with an integrated generator,
a power electronic converter 104,
a computer control unit 105.

The hot heat-transfer salt pumped by means of the pump 41 located above the collector 40 or 50, is conveyed towards the secondary heat exchanger 101, disposed outside the reactor 100.

The secondary heat exchanger 101 allows exchanging heat between the reheated heat-transfer salt and carbon dioxide, these two fluids circulating in counter-current. It consists of a vessel equipped with a U-shaped multi-tube exchanger, both made of Hastelloy®-N. The U-shaped multi-tubes are crossed by carbon dioxide whereas the heat-transfer salt fills the main chamber of the vessel where the multi-tubes are installed.

At the outlet of the secondary heat exchanger 101, the cooled heat-transfer salt is conveyed back towards the lateral cavity 201 of the reactor by a hose to be pushed there towards the heat-transfer salt channels of the primary heat exchanger (the matrix) of the core. All of the heat-transfer salt piping outside the reactor 100 may be made of Hastelloy®-N.

The heat-transfer salt piping and the secondary heat exchanger 101 are equipped with a trace heating system allowing for a rapid rise in temperature of the salt during the start-up phase. Indeed, after cold shut-down, the heat-transfer salt is crystallised at room temperature. Salt melting is reached at a temperature higher than about 450° C. depending on the actual composition of the salt. The tracing system enables the salt located outside the reactor to reach the liquid phase. The tracing system is powered only upon cold start-up of the reactor.

The heat-transfer salt circuit further includes a device allowing accepting up to 25% expansion of the entire volume of heat-transfer salt between its crystallised solid phase at low temperature, and its liquid phase when the salt is molten at high temperature.

The power of the core is controlled by the amount of heat extracted from the core, therefore by the flow rate of the heat-transfer salt thanks to the control of the heat-transfer salt extraction pump 41. This parameter is the only operating parameter of the reactor that is actively controlled.

At the outlet of the secondary heat exchanger 101, the carbon dioxide in the supercritical phase is sent to a closed-cycle turbine 103 with re-compression to transform the heat into mechanical energy. The operating cycle of the used fluid (carbon dioxide in the supercritical phase) in the turbine comprises a two-stage compression, with intermediate cooling of only part of the fluid, which allows recycling a larger amount of heat.

The supercritical CO₂ cycle is very interesting in thermodynamics terms and in terms of size of the turbine. The two main technological constraints are making of heat exchangers in particular in the circum-critical area in order to avoid any crossing of the temperatures, and that of efficient turbomachines for carbon dioxide.

The main flow rate of the fluid coming out of the secondary heat exchanger 101 enters the turbine 103 at 200 bars and about 550° C. to be expanded therein, and comes out at 79 bars and about 440° C. towards a first tertiary high-temperature exchanger to drop to about 168° C.-79 bars, then in a second tertiary low-temperature exchanger to drop to about 70° C.-77 bars, before being split into two flows (the two tertiary exchangers associated with the turbine, respectively the high- and low-temperature ones, are shown in FIG. 10 by the block 102):
a portion is cooled in a pre-cooler, to drop to about 32° C.-77 bars, then compressed in the main compressor from about 77 to 200 bars, and finally reheated to about 158° C. in the low-temperature exchanger;
the other portion is compressed to 200 bars in the recompressor, then mixed with the other flow coming out of the low-temperature exchanger.

Afterwards, the total flow rate is reheated to 397° C. in the high-temperature exchanger before returning towards the salt/CO₂ secondary heat exchanger 101, and the cycle is thus closed.

The two tertiary heat exchangers (CO₂/CO₂ exchangers) 102 of the turbine are of the printed circuit heat exchanger (PCHE) or triply periodic minimum surface (TPMS) type and are herein located above the turbine 103. The low-temperature cooler (CO₂-Air) is of the multi-tube finned type with cross mixing, and the ambient air mixing fan may be located at the end of the main axis of the generator or in a device independent of the axis of the generator.

The inlet temperature in the secondary heat exchanger 101 (salt/CO₂ exchanger) is higher than it would be in the absence of the tertiary exchangers 102, and with assumptions on the polytropic efficiencies of the turbomachines in the range of 90% and the efficiencies of the exchangers in the range of 95%, the overall efficiency approaches 50%. Thanks to the heat recovery in the closed-cycle CO₂ turbine (in the PCHE or TPMS type exchangers 102 for example), the temperature of the CO₂ “cooled down” by the turbine is higher than in the absence of heat recuperators 102, which guarantees a lower delta of inlet/outlet temperatures of the secondary exchanger 101 and therefore a higher overall efficiency. A helical circulation pump is integrated into the rotation shaft of the turbine and located just after the first decompression stage for more compactness.

The rotational speed of the turbine 103 is in the range of several tens of thousands of revolutions per minute.

The turbine is coupled to a very high speed electric generator, preferably via an epicyclic gear train, allowing transforming the rotational mechanical power into a current-voltage controlled three-phase electric power. In the illustrated example, the generator is integrated into the block 103, which is consequently referred to as a turbine with an integrated generator.

The electric current thus generated is sent to a power electronic converter 104 allowing ensuring a rated voltage and a frequency corresponding to local standards.

The axis of the generator is also equipped with an electric motor intended for starting the turbine, in particular to ensure the initial circulation flow of carbon dioxide, in particular upon a cold start-up of the reactor.

As indicated before, the electrogenerator also comprises a computer control unit 105, for the passive monitoring of some operating parameters measured using various sensors, and for the active control of the heat-transfer salt extraction pump 41. This control unit integrates telecommunication means like for example a 5G connection at least, allowing on the one hand transmitting the values measured for the monitored operating parameters, and on the other hand remotely controlling the heat-transfer salt extraction pump 41 in order to adjust the temperature of the core of the reactor or to control the shut-down of the reactor, for example.

Moreover, the outer case is equipped with orientable fins 107 which can be opened to ensure ventilation between the inside and the outside of the case in the event of overheating. These ventilation fins can be placed in the open position, either automatically when the temperature of air inside the outer case exceeds a predetermined threshold, or using a remote control. Nonetheless, they are sized so as not to enable any access to the elements of the electrogenerator, in particular to the reactor and to the control unit, in order to prevent any risk of contamination and to avoid any possibility of hacking the reactor or the electrogenerator.

1. A molten salt nuclear fission reactor comprising:
a reactor core crossed by a fuel salt comprising fission-capable heavy nuclei,
a primary enclosure containing the reactor core, which primary enclosure is impermeable to liquid salts,
a shelter in which the primary enclosure is accommodated,
the reactor core comprising a parallelepipedal matrix comprising an alternation of layers of fuel salt channels, in which the fuel salt circulates, and layers of heat-transfer salt channels, in which a heat-transfer salt circulates,
heat-transfer salt circulation means for circulating the heat-transfer salt within the primary enclosure between a heat-transfer salt inlet opening of the primary enclosure, the heat-transfer salt channels of the matrix, then a heat-transfer salt outlet opening of the primary enclosure,
fuel salt circulation means for circulating the fuel salt in the fuel salt channels of the matrix,
wherein the fuel salt circulation means are configured to extract the fuel salt from one portion of the fuel salt channels through one face of the matrix and to propel the fuel salt into the other portion of the fuel salt channels through this same face of the matrix.

2. The reactor according to claim 1, wherein the fuel salt circulation means are configured to circulate the fuel salt only inside the primary enclosure, in a closed cycle without regeneration of the fuel salt, the primary enclosure having no fuel salt outlet.

3. The reactor according to claim 1, wherein the shelter comprises at least one reflective layer made of a carbonaceous material, oriented towards the reactor core and configured to make the fuel salt critical, and a shielding layer for abating residual radiations and neutrons, configured to absorb or neutralise the gamma radiations originating from the reactor core and/or from the reflective layer as well as residual leakage neutrons which would manage to pass through the reflective layer of the shelter.

4. The reactor according to claim 1, wherein all fuel salt channels extend, in the layers of fuel salt channels, according to a vertical direction orthogonal to an upper face of the matrix, and all heat-transfer salt channels extend, in the layers of heat-transfer salt channels, according to a direction orthogonal to a first one of the lateral faces of the matrix.

5. The reactor according to claim 4, wherein the fuel salt circulation means comprise at least:
an element, called the central collector, arranged in the primary enclosure opposite, above, an upper face of the matrix, said primary collector comprising on one side a large base adjacent to the upper face of the matrix, which large base covers a central portion or slice of the upper face, and on the other side a top opening, an inner face in the form of a pyramidal hopper connecting the large base to the top opening,
and a centrifugal pump, arranged in the primary enclosure opposite, above, the top opening of the central collector.

6. The reactor according to claim 4, wherein the heat-transfer salt circulation means comprise:
an element, called the collector, integrated into the primary enclosure, the collector having on one side a large base adjacent to the first lateral face of the matrix and on another side at least one opening connected either to the heat-transfer salt inlet opening of the primary enclosure, or to the heat-transfer salt outlet opening of the primary enclosure,
one or two pumps arranged outside the primary enclosure.

7. The reactor according to claim 1, wherein the matrix is made in one-piece.

8. The reactor according to claim 1, wherein the matrix is made of one or more material selected from among: graphene, silicon carbide foams, graphene and silicon carbide foams, combinations of the previous materials.

9. The reactor according to claim 1, wherein the matrix is obtained by 3D printing.

10. The reactor according to claim 3, wherein the shelter comprises a layer of thorium between the reflective layer and the shielding layer, which thorium layer is intended to be fertilised by absorption of leakage neutrons which escape from the primary enclosure and are slowed down by the reflective layer.

11. The reactor according to claim 1, further comprising:
a gaseous headspace above the matrix,
a gaseous fission product recovery tank, connected to the gaseous headspace,
a neutral gas buffer tank and means for injecting said neutral gas into the gaseous headspace for the purposes of compensating for variations in the volume of the fuel salt.

12. The reactor according to claim 1, wherein a trace preheating system is provided in the heat-transfer salt circulation means.

13. The reactor according to claim 1, further comprising a device for controlling the circulation flow rate of the heat-transfer salt in the reactor.

14. The reactor according to claim 1, wherein the matrix is a cube with a 35 cm to 120 cm side and/or whose fuel salt volume in the liquid state is less than 500 litres.

15. The reactor according to claim 1, wherein the fuel salt channels and the heat-transfer salt channels have a dimension comprised between 5 mm and 12 mm in the thickness direction of the fuel salt layers and the heat-transfer salt layers.

16. The reactor according to claim 4, wherein:
the fuel salt channels are rectilinear and open-through, extending from the upper face of the matrix to a lower face of the matrix,
an upper cavity is provided between the upper face of the matrix and an upper wall of the primary enclosure to accommodate the fuel salt circulation means, excluding the motor drive and control elements of said fuel salt circulation means,
a lower circulation and homogenisation cavity is provided between the lower face of the matrix and a lower wall of the primary enclosure,
the fuel salt circulation means comprise, on the side of the upper face of the matrix, a central collector and a centrifugal pump, the central collector having a large base covering a central portion or a central slice of the upper face of the matrix, an inner face in the form of a pyramidal hopper and a top opening, the centrifugal pump being configured to propel the fuel salt coming from the top opening of the central collector towards the peripheral portion or the peripheral slices of the upper face of the matrix.

17. The reactor according to claim 4, wherein:
each layer of fuel salt channels comprises two U-shaped fuel salt channels arranged symmetrically on either side of a central axis of said layer, each U-shaped fuel salt channel having an outlet end located in a central slice of the upper face of the matrix and an inlet end located in a peripheral slice of said upper face,
an upper cavity is provided between the upper face of the matrix and an upper wall of the primary enclosure to accommodate the fuel salt circulation means excluding the motor drive and control elements of said fuel salt circulation means,
the fuel salt circulation means comprise, on the side of the upper face of the matrix, a central collector and a centrifugal pump, the central collector having a large base covering a central slice of the upper face of the matrix, an inner face in the form of a pyramidal hopper and a top opening, the centrifugal pump being configured to propel the fuel salt coming from the top opening of the central collector towards the peripheral slices of the upper face of the matrix.

18. The reactor according to claim 4, wherein:
the heat-transfer salt channels are rectilinear and open-through, extending from the first lateral face of the matrix up to a second lateral face of the matrix, opposite to the first lateral face, all heat-transfer salt channels having an inlet end on the side of the first lateral face of the matrix and an outlet end on the side of the second lateral face of the matrix,
an upstream mixing cavity is provided between the first lateral face of the matrix and a first lateral wall of the primary enclosure,
a downstream mixing cavity is provided between the second lateral face of the matrix and a second lateral wall of the primary enclosure,
the heat-transfer salt inlet opening of the primary enclosure opens into the upstream mixing cavity, whereas the heat-transfer salt outlet opening of the primary enclosure opens into the downstream mixing cavity,
the heat-transfer salt circulation means comprise at least one pump external to the primary enclosure, configured to inject the heat-transfer salt into the upstream mixing cavity through the heat-transfer salt inlet opening of the primary enclosure or to extract the heat-transfer salt from the downstream mixing cavity through the heat-transfer salt outlet opening of the primary enclosure.

19. The reactor according to claim 4, wherein:
each layer of heat-transfer salt channels comprises two U-shaped heat-transfer salt channels arranged symmetrically on either side of a central axis of said layer, each U-shaped heat-transfer salt channel having one end located in a central slice of the first lateral face of the matrix and another end located in a peripheral slice of said first lateral face,
one single lateral cavity is provided, between the first lateral face of the matrix and a first lateral wall of the primary enclosure,
the heat-transfer salt inlet opening and the heat-transfer salt outlet opening of the primary enclosure are both provided to open into the single lateral cavity.

20. The reactor according to claim 19, wherein the heat-transfer salt circulation means comprise an integral collector with integrated ducts, the integral collector having an inner front face, an opposite outer front face and four sidewalls,
the inner front face forming a pyramidal central hopper extending opposite the central slice of the first lateral face of the matrix, and two pyramidal peripheral hoppers extending opposite the two peripheral slices of the first lateral face of the matrix,
the central hopper being extended by a duct formed across the thickness of the collector and leading into a first lateral opening located on one of the sidewalls of the collector, each of the peripheral hoppers being extended by a secondary duct formed across the thickness of the collector, which secondary ducts join a main duct which opens into a second lateral opening located on one of the sidewalls of the collector, the first lateral opening of the collector being connected to the heat-transfer salt outlet opening of the primary enclosure, whereas the second opening of the collector is connected to the heat-transfer salt inlet opening of the primary enclosure, or vice versa.

21. An electrogenerator, comprising:
a nuclear fission reactor according to claim 1,
a secondary heat exchanger, supplied with hot heat-transfer salt coming out of the reactor, and in which the hot heat-transfer salt transfers heat to carbon dioxide in the supercritical phase,
a supercritical CO₂ turbine connected to the outlet of the secondary heat exchanger,
an electric generator coupled to or integrated with the supercritical CO₂ turbine,
a power electronic converter.

22. The electrogenerator according to claim 21, further comprising an outer case enclosing the nuclear fission reactor, the secondary heat exchanger, the supercritical CO₂ turbine, the electric generator and the power electronic converter, the outer case also containing a computer control unit with telecommunication means allowing remotely controlling the control unit,
and wherein the outer case comprises orientable and motor-driven ventilation fins which can be pivoted between a closed position in which the external case is sealed and an open position enabling the circulation of air between the inside and the outside of the case.
